(19) United States
(12) Patent Application Publication
(10) Pub. No.: US 2021/0056478 A1
(43) Pub. Date: Feb. 25, 2021

(54) Cloud Migration Readiness: An Automated Self-Diagnostic Model

(71) Applicant: Prashant S. Mishra, Redmond, WA (US)

(72) Inventor: Prashant S. Mishra, Redmond, WA (US)

(21) Appl. No.: 16/547,629

(22) Filed: Aug. 22, 2019

(51) Int. Cl. G06Q 10/06; G06F 8/65; G06Q 10/10; H04L 29/08

(52) U.S. Cl. CPC G06Q 10/0637; G06F 8/65; G06Q 10/0635; H04L 67/34; G06Q 10/0633; H04L 67/1097; G06Q 10/10

(57) ABSTRACT

This invention will be used to determine how ready a user is to begin migrating their workload to a Cloud. Each client will provide some general information about the workload they wish to migrate. Based on the user's responses, a data visualization—in the form of a meter—will be formulated to determine the user's readiness score. Additionally, this tool will help the user better understand their unique challenges or issues that must be resolved before migration can occur. A cloud readiness report is generated at the end of this process, which will tell the user the specific issues that may hinder their migration process. With the help of invention, users can cut down their time and cost for checking their cloud readiness status. This tool will assist clients to identify any issues that would interfere with their migration to a cloud.

### TECHNICAL FIELD

The present invention relates generally to a data assessment system and a data visualization, more particularly evaluating technical components that determine cloud migration readiness.

### BACKGROUND OF THE INVENTION

Business owners and individuals are becoming more aware of the advantages of using Cloud technology to assist in their organizations.

The process of adopting Cloud into their business or technology suite is often an intimidating and confusing process. Due to lack of time and resources to research the steps that must be taken to migrate a workload to a Cloud, many business owners abandon the process early on and therefore miss out on valuable opportunities to improve their business practices.

Additionally, each workload migration is unique and could propose a large number of issues that could hinder the process of migrating the package from source to destination. Programming languages, Software Development Kits, Databases, Software Versions, Cloud Support, and many other components influence the ability of a workload to be migrated.

Some business owners hire technical consultants to analyse their workloads and identify the organization's current issues. However, this is an expensive task and would require a minimum of one week for a full report to be issued to the business owner.

This invention addresses this problem encountered by countless businesses and individuals in today's age.

The inventor has over 20 years of experience with Information Technology and Cloud management. The inventor has identified the above-described concern as one of the first issues that must be resolved for the advancement of Cloud technology, integration, and management.

### SUMMARY OF THE INVENTION

The objective of the Cloud Migration Readiness model is to provide an automated self-diagnostic status about cloud migration and a readiness report. This software will help clients to assess the completeness of all their mandatory technical components based on the readiness report generated. The client will see a User Interface (UI) that is simple to understand. This automated self-diagnostic model will guide the client through each step and give a real-time readiness indication in the format of a meter. At the end, the tool will generate a report about the status of the workload to be migrated and the potential issues that would occur with that unique migration. See FIG. 1 and FIG. 2, respectively, for contextual and visual illustrations of the overall process.

There is a formula that calculates the user's readiness score. This formula is calculated with the information that the user inputs, and hence, is self-diagnostic in nature. The client is able to input specific information based on their understanding of their own needs. Each client will have unique migration requirements, software, workload configurations, and cloud setup.

As the client submits their migration requirements and information throughout the four stages of the UI tool, the backend of the UI tool will calculate the client's readiness score in real time. By the end of the fourth stage of the UI tool, the client will have a cumulative readiness score. The tool is currently calculated on a percentage basis. Clients visualize this readiness score as a meter.

At the end of each stage, the user will be able to view their readiness score in the same webpage. By viewing their score at each stage, users will be able to better understand which parts of their workload migration are going to require extra resources to find solutions.

In stage One of the UI tool, the client answers simple questions about their migration requirement. This stage is an Assessment and relays the information clients enter to the backend of the UI tool for cumulative calculations.

Identifying the migration requirement, such as from Cloud-to-Cloud or Virtual Machine-to-Cloud, is the first step in the process. The Cloud-to-Cloud migrations and Virtual Machine-to-Cloud migrations are deemed to be straight-forward and more simple processes than migrating from Data-to-Cloud or Storage-to-Cloud. This is due to the fact that there are additional steps that must be taken to convert Databases and Storage types into packages that can be migrated. Hence, the migration requirement indicated by the user factors into the user's overall migration readiness score.

The user also is asked to identify the source and destination of the package they wish to migrate. By doing so, the formula can assess the compatibilities between the starting and ending point of the migration. For example, some databases are not completely compatible with certain clouds and an extra step must be completed before a migration can be initiated. Similarly, when a user indicates that the source destination is on-premise, it is necessary to first move the package to an online system before packaging and migrating. Situations such as these reduce the user's readiness score for migration.

In stage Two of the UI tool, the client enters information about the configuration of their workload. This information is used for Mapping the key elements of the workload and identify incompatibilities that could cause a delay or termination of a workload migration.

Key elements of the workload, such as Databases, software Versions, Programming Languages, and Application Programming Interfaces (APIs) are compared for compatibility by the backend of the UI tool. Application Programming Interfaces, which is a software intermediary that allows two applications to “talk” to each other are almost always compatible. However, databases are not always able to be migrated from source to destination without extra assistance. Databases must communicate with the APIs in order for apps and software to operate smoothly. Before migrating to a Cloud, the client must ensure that the APIs, Databases, and all other components of the Software Development Kits (SDKs) are updated to the desired versions. Also, the client must ensure that the destination Cloud has the available infrastructure to support the APIs, Databases, SDKs, and the overall functionality of the workload.

In stage Three of the UI tool, the client enters information regarding Hosting. The Hosting component of the user's readiness score is determined by the availability of the client's desired Domain Name with their Hosting Provider of choice. The User can utilize a search engine within the UI tool to verify the availability of their desired hosting location and domain name.

In stage Four of the UI tool, the client indicates if there are any limitations regarding Deployment. The key factor that would impede the migration process is the presence of an internal security feature. Internal firewalls, security certificates, and other forms of security will take additional time and expertise to disable in the workload source. This requires additional planning by technology security specialists.

The final information that users provide is whether they need a personalized pre- and post-deployment report. Ideally, a user has received a score of 100% in the UI tool and will not require further reporting. However, in the real world, there will likely be issues with the user's workload migration. The option of receiving a comprehensive report enables the user to later address each issue or obstacle before attempting to migrate their workload.

### DETAILED DESCRIPTION OF THE INVENTION

Cloud Migration Readiness is determined throughout four stages. Each of the four stages are worth one-quarter, or 25%, of the overall score. See Line 350 of FIG. 3.

The first stage, Assessment, contributes up to 25% of the total readiness score. See Line 310 of FIG. 3.

Stage 1 begins with Section 801 in FIG. 8.

Question one in the Assessment stage in Section 401 of FIG. 4 is calculated on the following basis:
IF user identifies migration requirement to be Cloud to Cloud, THEN begin score at 10%.
IF user identifies migration requirement to be Virtual-machine to Cloud, THEN begin score at 10%.
IF user identifies migration requirement to be Database to Cloud, THEN begin score at 0%.
IF user identifies migration requirement to be Storage to Cloud, THEN begin score at 0%.

Cloud to Cloud and Virtual-machine to Cloud migrations are not difficult to complete, hence, these two types of migrations would contribute 10% to the overall cloud migration readiness score. On the other hand, Database to Cloud and Storage to Cloud migrations pose more difficulties and will not contribute to the user's readiness score.

Questions two and three in the Assessment stage in Section 401 of FIG. 4 is calculated on the following basis:

IF user selects source and destination clouds that are compatible, THEN add 10%.

IF user selects source and destination clouds that are NOT compatible, THEN add 0%.

Software Development Kits (SDKs) are built into the function of its host cloud. If two SDKs used in separate clouds are incompatible, then the middle lay between two Clouds will find difficulties in communicating with each other. If the two SDKs in the middle layer are incompatible, then issues will arise during migration, hence contributing nothing towards a user's readiness score. On the other hand, if two SDKs in the middle layer are indeed compatible, 15% will be added to the user's readiness score.

If all components are valid, as shown in Section 802 of FIG. 8, then user continues to Section 804 of FIG. 8.

If all components are not valid, as shown in Section 803 of FIG. 8, then user must return to Section 801 of FIG. 8 and repeat the process.

The second stage, Mapping, contributes up to 25% of the total readiness score. See Line 320 of FIG. 3.

Stage 4 begins with Section 901 in FIG. 9.

Question one of the Mapping stage in Section 501 in FIG. 5 is not used to calculate a user's migration readiness score. It is essential to the function of the tool, however, because not all clients may have a database to migrate. For those who select, “No”, question number two in Section 501 in FIG. 5 will also remain blank and will not negatively impact a final readiness score.

Question two of the Mapping stage in Section 501 in FIG. 5 is calculated on the following basis:

IF user selects a database that is able to be upgraded in the cloud, THEN add 15%.

IF user selects a database that is NOT able to be upgraded in the cloud, THEN add 0%

Question three of the Mapping stage in Section 501 in FIG. 5 is calculated on the following basis:
IF user selects a programming language that is compatible with the pre-determined databases and SDKs, THEN add 5%.
IF user selects a programming language that is NOT compatible with the pre-determined databases and SDKs, THEN add 0%.

Question four of the Mapping stage in Section 501 in FIG. 5 is calculated on the following basis:
IF user selects an API that is compatible with the pre-determined databases and SDKs THEN add 5%.
IF user selects an API that is NOT compatible with the pre-determined databases and SDKs, THEN add 0%.

If all components are valid, as shown in Section 902 of FIG. 9, then user continues to Section 904 of FIG. 9.

If all components are not valid, as shown in Section 903 of FIG. 9, then user must return to Section 901 of FIG. 9 and repeat the process.

In the mapping stage, it is essential to first determine if a user needs to migrate a database to their target cloud. If not, the tool skips to Question 2. Regardless of the user's answer to Question 1, the user then must provide information about the databases (if applicable), programming languages, and APIs that are currently used. Using this information, the tool determines if all of the above-mentioned components are compatible with the target Cloud.

The third stage, Hosting, contributes up to 25% of the total readiness score. See Line 330 of FIG. 3.

Stage 4 begins with Section 1001 in FIG. 10.

Question one of the Hosting stage in Section 601 in FIG. 6 is calculated on the following basis:
IF user selects a hosting provider that is compatible with the source cloud, THEN add 5%.
IF user selects a hosting provider that is NOT compatible with the source cloud, THEN add 0%.

Question two of the Hosting stage is a search engine of available domain names.

Question two of the Hosting stage in Section 602 in FIG. 6 is calculated on the following basis:
IF user searches and selects a desired domain name that is available for purchase from the hosting provider, THEN add 20%.
IF user searches and selects a desired domain name that is NOT available for purchase from the hosting provider, THEN add 0%.

If all components are valid, as shown in Section 1002 of FIG. 10, then user continues to Section 1004 of FIG. 10.

If all components are not valid, as shown in Section 1003 of FIG. 10, then user must return to Section 1001 of FIG. 10 and repeat the process.

Most hosting providers are up-to-date and can be utilized with almost any programming languages, APIs, and other technical components. However, there are a few that are only suited for older technology. Asking the user to identify the hosting provider that the package will be migrated to and hosted on will allow the tool to flag any known issues with hosting. Additionally, the tool asks the user to enter their desired domain name. Nearly zero small or medium business owner will have purchased a domain name to host their soon-to-be migrated packages.

The fourth stage, Pre- and Post-Deployment, contributes up to 25% of the total readiness score. See Line 340 of FIG. 3.

Stage 4 begins with Section 1101 in FIG. 11.

Question one of the Pre- and Post-Deployment stage in Section 701 in FIG. 7 is calculated on the following basis:

IF user selects “Yes”, THEN add 0%.

IF user selects “No”, THEN add 25%.

IF user selects “Unsure”, THEN add 0%.

Question two of the Pre- and Post-Deployment stage in Section 701 in FIG. 7 is not used to make a calculation. Instead, the following actions are taken:
IF user selects “Yes”, THEN collect user's credentials in Question three of the Pre- and Post-Deployment stage and email user a written description of their final readiness score.
IF user selects “No”, THEN skip Question three of the Pre- and Post-Deployment stage and calculate the user's readiness score.
IF user selects “Unsure”, THEN collect user's credentials in Question three of the Pre- and Post-Deployment stage and email user a written description of their final readiness score.

Question three of the Pre- and Post-Deployment stage in Section 701 in FIG. 7 is not used to make a calculation. Instead, the user's credentials are gathered. The purpose of this is two-fold. First, the user will receive an automated email that outlines the reasoning behind their readiness score. Secondly, a copy of the user's credentials is automatically forwarded to the inventor's engineers if the user indicates that permission to access their cloud account is granted. The engineers can analyse the user's cloud account to offer more migration solutions for the user's unique requirements and migration hurdles.

If all components are valid, as shown in Section 1102 of FIG. 11, then user continues to Section 1104 of FIG. 11.

If all components are not valid, as shown in Section 1103 of FIG. 11, then user must return to Section 1101 of FIG. 11 and repeat the process.

User logically clicks on the “Calculate” button at the bottom of Section 701 in FIG. 7. The meter that is shown is the final cloud readiness score as per the user's inputs. At this point, the process is complete as shown in Section 1104 of FIG. 11. Also, see Line 350 of FIG. 3.

### FIGURES OF THE INVENTION

FIG. 1: Roadmap of Cloud Migration Readiness Meter

FIG. 2: User Interface Workflow

FIG. 3: Accumulative Percentage of Stages

FIG. 4: Stage 1 of User Interface: Assessment

FIG. 5: Stage 2 of User Interface: Mapping

FIG. 6: Stage 3 of User Interface: Hosting

FIG. 7: Stage 4 of User Interface: Pre & Post Deployment

FIG. 8: Flowchart: Stage 1

FIG. 9: Flowchart: Stage 2

FIG. 10: Flowchart: Stage 3

FIG. 11: Flowchart: Stage 4

### DESCRIPTIONS OF FIGURES

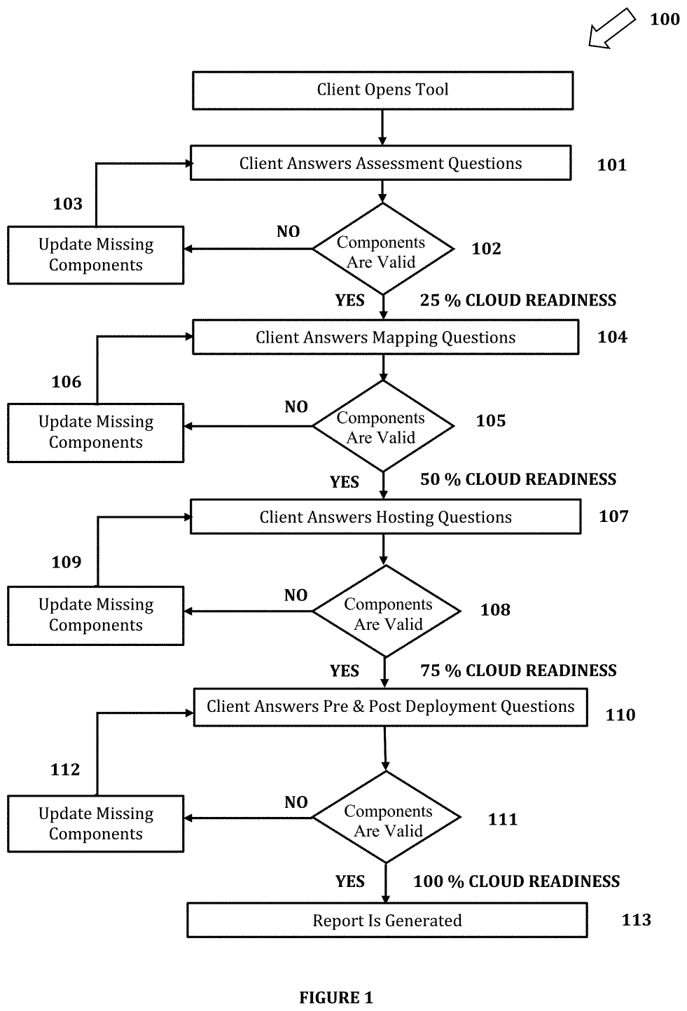

FIG. 1: Flow chart Drawing 100 indicates the process begins when a user opens the tool. Whenever a component is validated, the user may move onto the next stage. If at any stage a component is not validated, then user will get a feedback message to update those missing components.

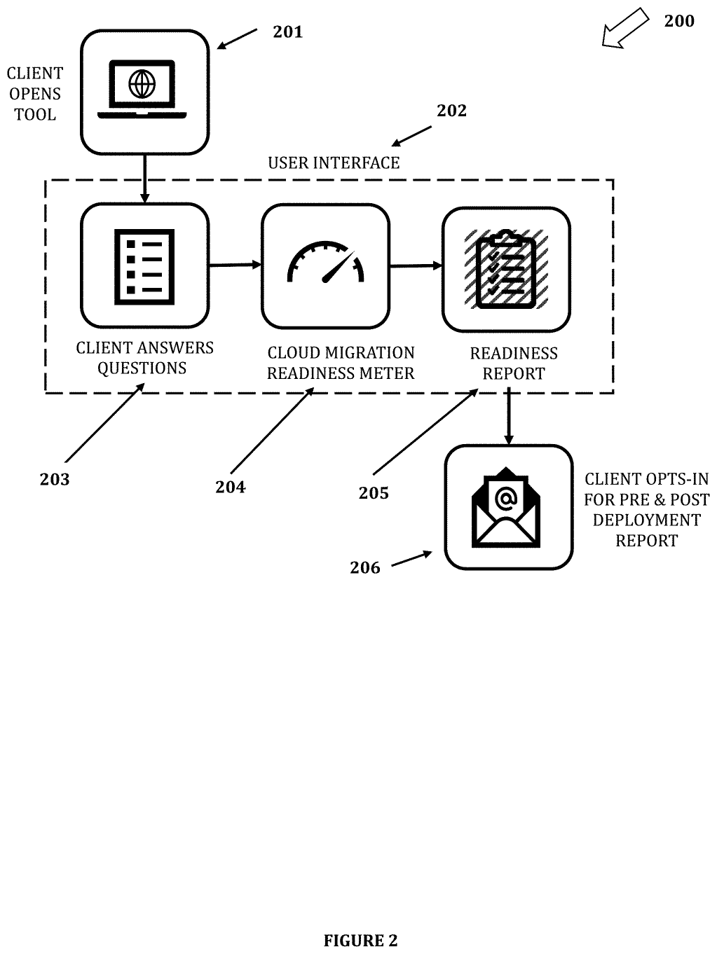

FIG. 2: Step 201 is the beginning of the process for a User. Group 202 is a group of three steps that comprise the User Interface; Step 203, Step 204, and Step 205. Step 206 is the final outcome of the actions taken during user engagement with the User Interface in Section 202.

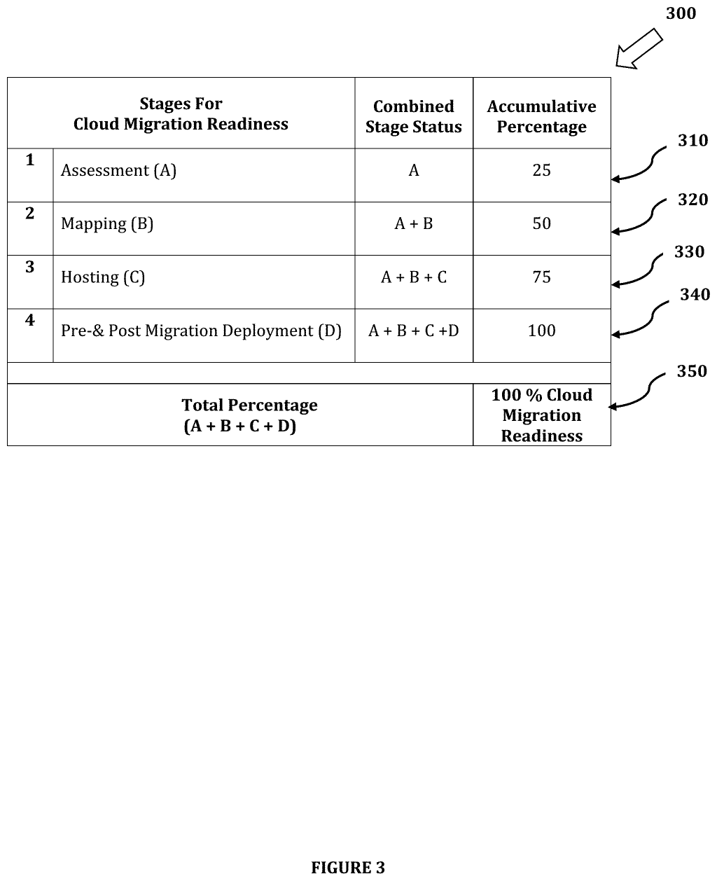

FIG. 3: Table 300 is a simplified version of a formula for the tool to calculate the percentage of a cloud migration readiness.

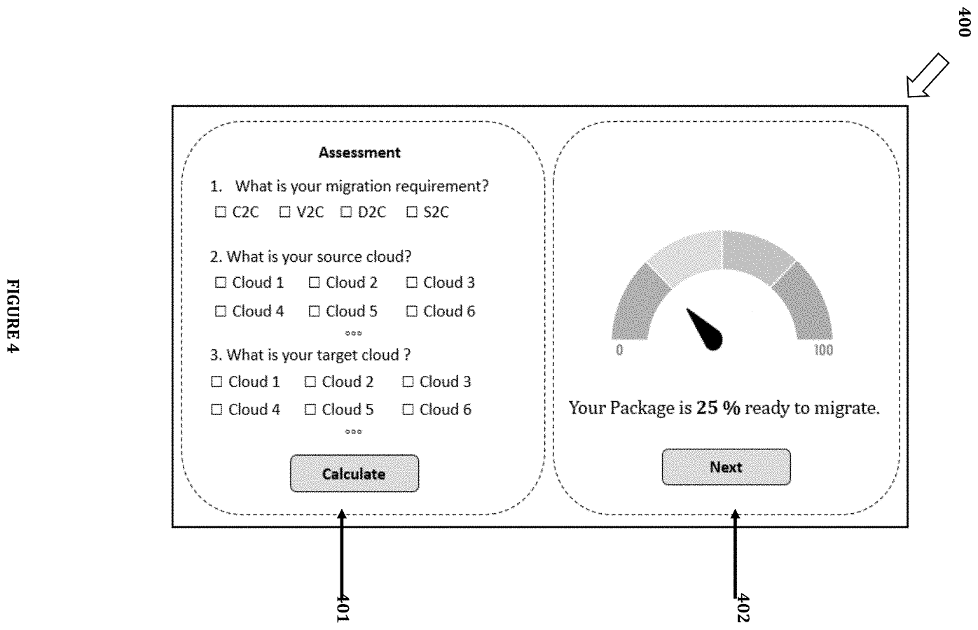

FIG. 4: Stage one of the UI tool, Assessment, is completed based on the user's inputs and accounts for up to 25% of the user's overall cloud migration readiness score. Score is calculated in real-time. Section 401 is the left side of the UI where the user must submit information. Section 402 is the right side of the UI where the user can visualize their readiness score in real-time.

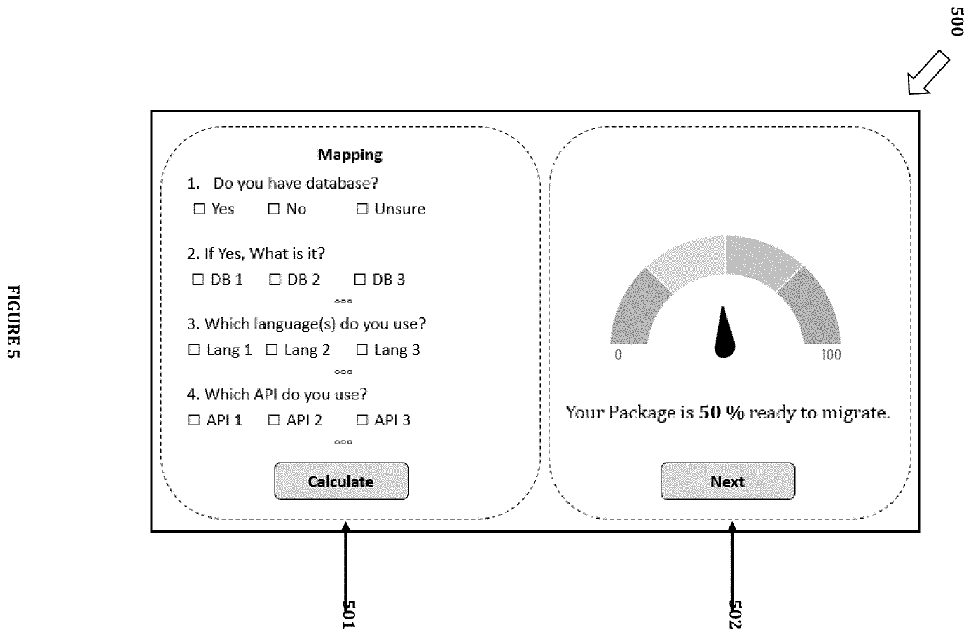

FIG. 5: Stage two of the UI tool, Mapping, is completed based on the user's inputs and accounts for up to an additional 25% of the user's overall cloud migration readiness score. The total accumulative score can be up to and including 50%. Score is calculated in real-time. Section 501 is the left side of the UI where the user must submit information. Section 502 is the right side of the UI where the user can visualize their readiness score in real-time.

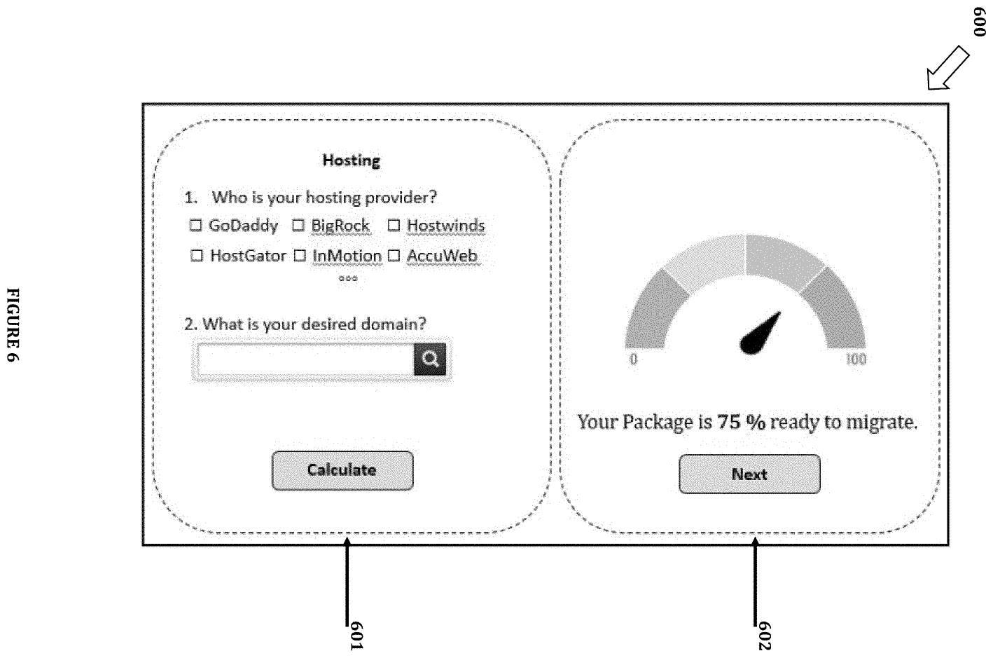

FIG. 6: Stage three of the UI tool, Hosting, is completed based on the user's inputs and accounts for up to an additional 25% of the user's overall cloud migration readiness score. The total accumulative score can be up to and including 75%. Score is calculated in real-time. Section 601 is the left side of the UI where the user must submit information. Section 602 is the right side of the UI where the user can visualize their readiness score in real-time.

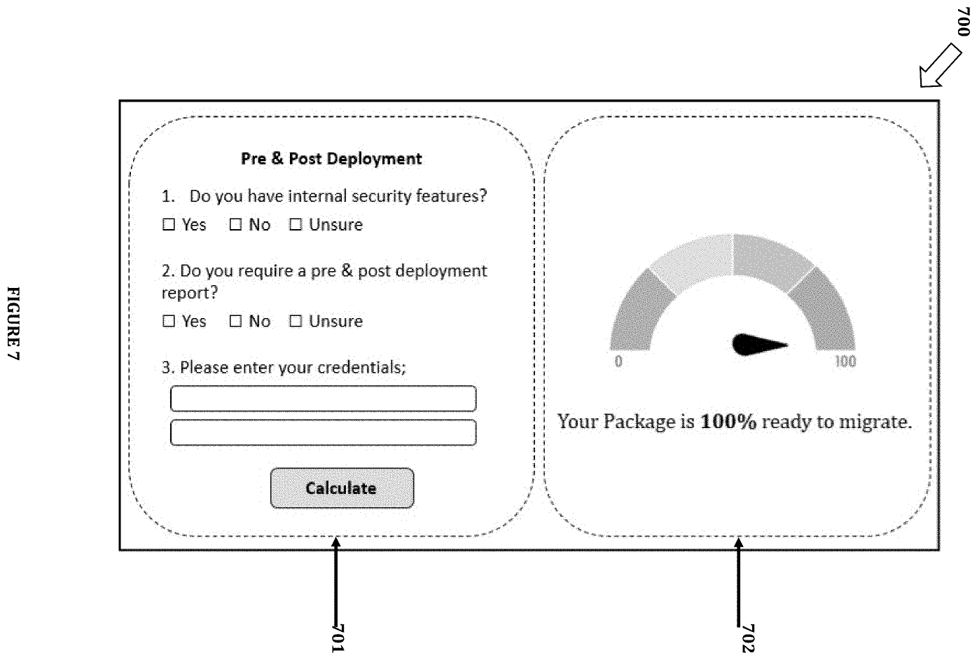

FIG. 7: Stage four of the UI tool, Pre & Post Deployment, is completed based on the user's inputs and accounts for up to an additional 25% of the user's overall cloud migration readiness score. The total accumulative score can be up to and including 100%. Score is calculated in real-time. Section 701 is the left side of the UI where the user must submit information. Section 702 is the right side of the UI where the user can visualize their readiness score in real-time.

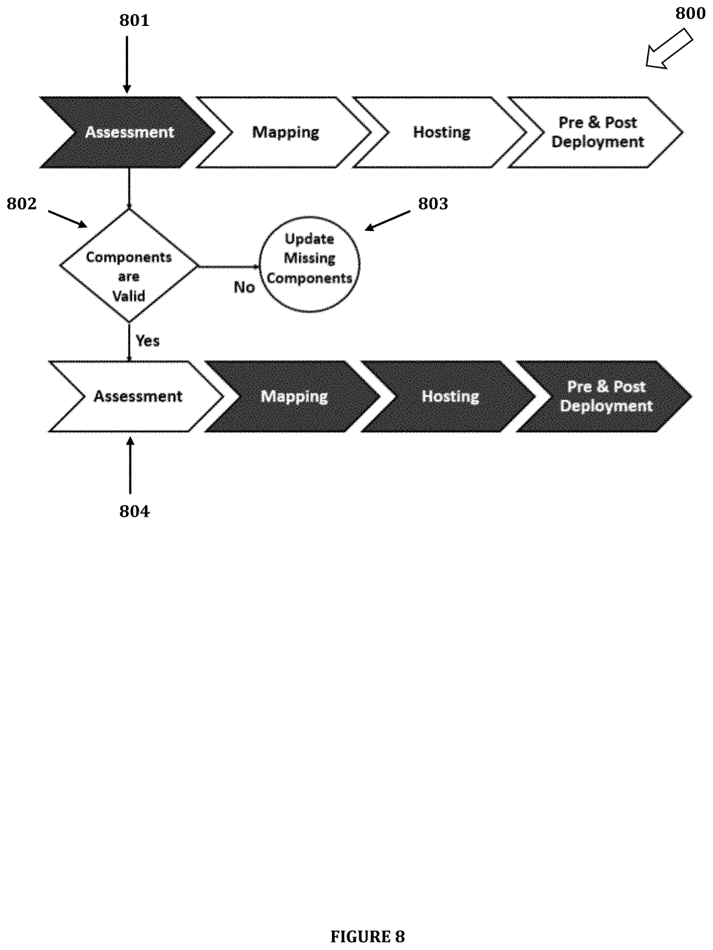

FIG. 8: Step 801, Assessment, must undergo a validation process before the tool can move on. If components of Step 801 are valid, as indicated in Step 802, the process may move forward. However, if the components of Step 801 are not valid, as indicated in Step 803, then missing components must be updated. Assessment is complete when Step 804 is reached.

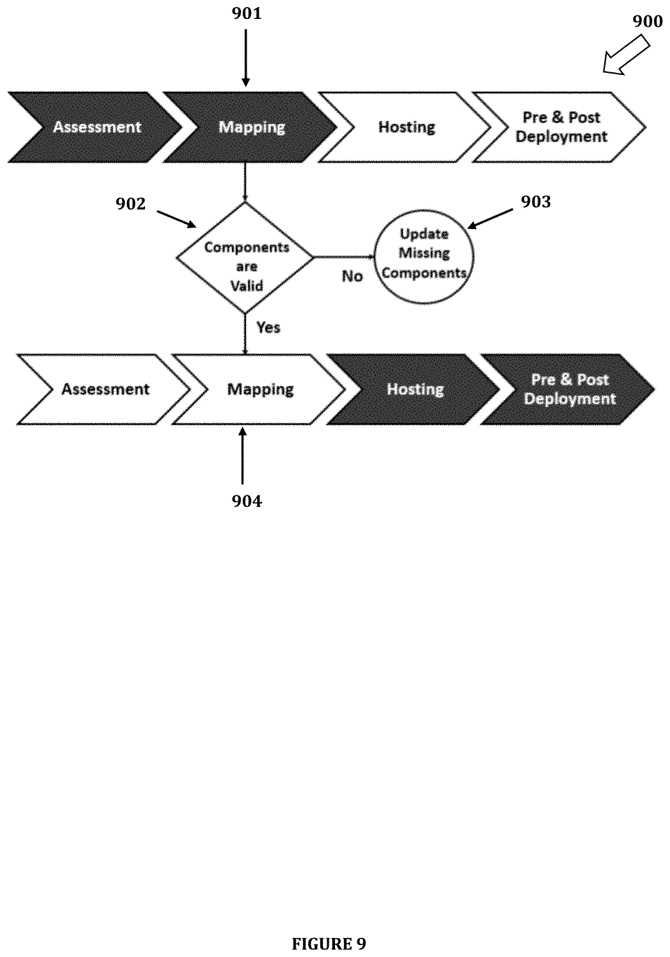

FIG. 9: Step 901, Mapping, must undergo a validation process before the tool can move on. If components of Step 901 are valid, as indicated in Step 902, the process may move forward. However, if the components of Step 901 are not valid, as indicated in Step 903, then missing components must be updated. Mapping is complete when Step 904 is reached.

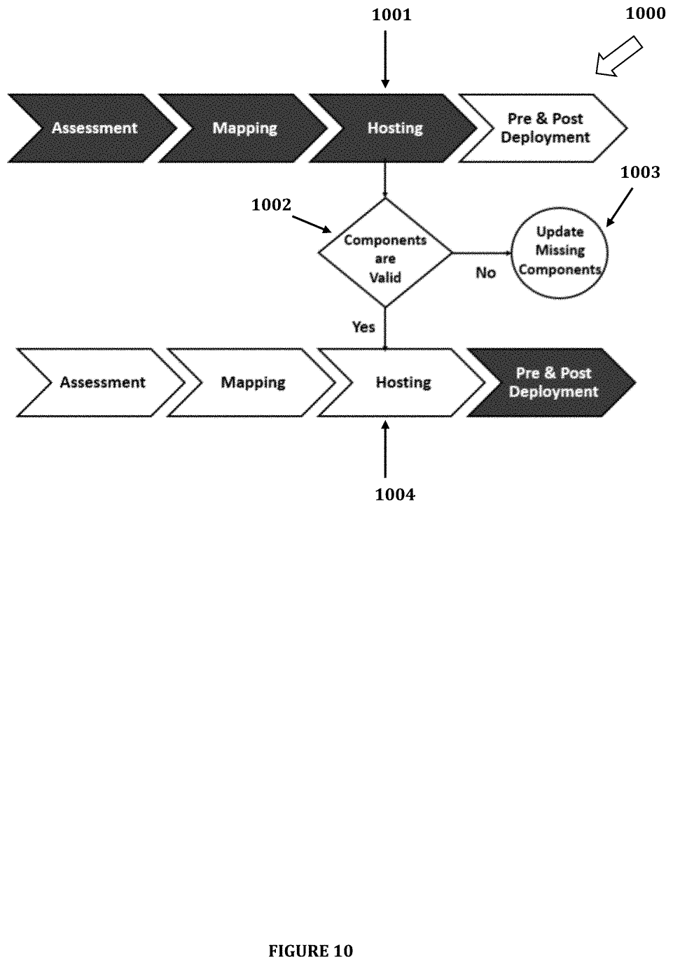

FIG. 10: Step 1001, Hosting, must undergo a validation process before the tool can move on. If components of Step 1001 are valid, as indicated in Step 1002, the process may move forward. However, if the components of Step 1001 are not valid, as indicated in Step 1003, then missing components must be updated. Hosting is complete when Step 1004 is reached.

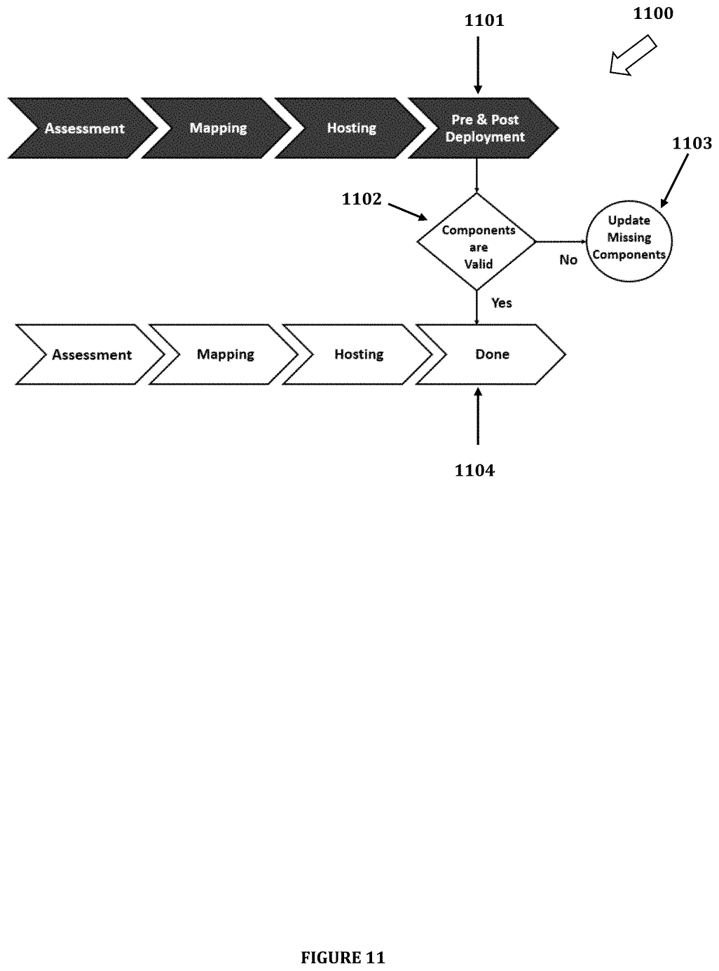

FIG. 11: Step 1101, Pre & Post Deployment, must undergo a validation process before the tool can move on. If components of Step 1101 are valid, as indicated in Step 1102, the process may move forward. However, if the components of Step 1101 are not valid, as indicated in Step 1103, then missing components must be updated. Pre & Post Deployment is complete when Step 1104 is reached.

1. A method comprising;
A tool to determine how ready organization is to migrate its workload on cloud;
Meter which visualize how much percent organization is ready to migrate.

2. A method providing;
Data visualization & assessment system;
Different factors which are responsible for successful migration for example programming language, software development kit, database, software version, cloud support etc.

3. A method provides;
Complete analysis of workload and identify organization's current issues;
An automated self-diagnostic status about cloud migration and a readiness report.

4. A method according to claim 3 wherein, the tool will help client to assess the completeness of all their mandatory technical components based on the readiness report generated.

5. A method included;
Formula that calculated the enterprise's migration readiness score;
The formula can access the compatibilities between the source cloud and destination cloud of the migration.

6. A method comprises;
Assessment stage between cloud to cloud, virtual machine to cloud, database to cloud, storage cloud.

7. A method comprises of
Validation of software of clouds;
If requires cloud software will updated and upgraded as per need.
